(19) United States
(12) Patent Application Publication
(10) Pub. No.: US 2017/0352022 A1
(43) Pub. Date: Dec. 7, 2017

(54) SYSTEM AND METHOD FOR DETERMINING SUBSCRIPTION INFORMATION BASED ON PAYMENT CARD TRANSACTION DATA OVER A PAYMENT CARD NETWORK

(71) Applicant: MASTERCARD INTERNATIONAL INCORPORATED, Purchase, NY (US)

(72) Inventors: David Senci, Troy, IL (US); Peng Yang, Chesterfield, MO (US)

(21) Appl. No.: 15/171,282

(22) Filed: Jun. 2, 2016

(51) Int. Cl. G06Q 20/34; G06Q 20/40

(52) U.S. Cl. CPC G06Q 20/34; G06Q 20/401

(57) ABSTRACT

A payment card processing system is configured to filter payment card transaction records to pass exclusively records having merchant identification data corresponding to merchants offering items via subscription, interact with a plurality of data storage devices to write a new subscription record for a given transaction to generate a new record in a subscription record database responsive to determining that the transaction represents a new subscription record, based at least on the merchant identifier data and account data in the transaction, and periodically updating one or more existing subscriptions records in a subscription record database.

### CROSS-REFERENCE TO RELATED APPLICATIONS

None.

### FIELD OF INVENTION

Embodiments relate to systems and methods that facilitate the determination of subscription based information of merchants and customers based on payment card transactions over a payment card network.

### BACKGROUND

Technological developments in the field of payment card networks and data security have made available simplified systems for provision of products and services in a subscription arrangement. In subscription arrangements of this type, the purchaser provides payments to the merchant on a recurring cycle, in an even amount. For example, the recurring cycle may be monthly, quarterly, annually, or another period. However, a monthly period is very common in current arrangements. In return, the merchant provides access to a resource on an ongoing basis, such as access to streaming or downloadable media, software, and a wide variety of other services. Improvements in technology around data security have made it possible for merchants to receive payment card data, store the payment card data on an ongoing basis, and receive prior authorization from the cardholder for the recurring charges. The merchant then submits transactions via the payment card network for approval on a recurring basis, without the need to obtain authorization from the cardholder for each payment. Without both payment card networks and advances in data security, such recurring transactions would not be feasible.

The new technological arrangement of recurring payments via payment card networks has generated a further innovation related to subscription services. Free trial periods of access to subscription services are made available contingent on receipt via a payment card network of an approval of a submitted transaction in an amount less than the level amount for the subscription. For example, the amount of the submitted transaction may be zero, or it may be a nominal amount, such as a minimum available amount in local currency, such as one cent in the U.S. or Canada. If the transaction in the amount less than the level amount for the subscription is approved via the payment card network, then the merchant provides the good or services to the customer. The merchant then submits for approval via the payment card network transactions on a recurring basis in level amounts. These transactions are then approved, and further network steps are taken to provide payment to the merchant.

A challenge that has arisen as a result of the availability of payment card networks, data security around payment card data, and the practice of providing an initial trial period of access, is that some card accounts may be used, on a recurring basis, to obtain access to services for the trial period, with the service canceled prior to submission by the merchant via the payment network of a first transaction at the level payment amount. As a result, merchants lose the benefit of recurring payments via the payment card network based on approved recurring transactions via the payment card network.

Alternative systems and methods are desired.

### SUMMARY

In some embodiments, a computer implemented method includes receiving, by a server processor, in a periodic batch extraction, from a data warehouse, a plurality of approved transaction messages made over a card payment network and stored in a payment card network database, each of said approved transaction messages including an account identifier data field, a merchant data field, an approved transaction date field, an amount field, authorization data field and clearance data field; filtering, by the server processor, the received approved transaction messages, using a filter, stored in memory and accessed by the server processor and loaded in random access memory, configured to pass exclusively transaction messages containing a merchant identifier data field value corresponding to one of a plurality of passing merchant identifier data field values, the passing merchant identifier data field values corresponding exclusively to merchants offering a periodic subscription for its services; and processing each filtered approved transaction message, the processing comprising: writing a new subscription record for a given transaction on a data storage medium to generate a new record in a subscription record database responsive to determining that the transaction represents a new subscription record, based at least on the merchant identifier data and account data in the transaction; and periodically updating one or more of the existing subscriptions records in the subscription record database.

In some embodiments, a computer system includes one or more communications devices for communicating filtered card transaction records, one or more data storage devices storing a subscription record database, and a processor, in communication with the one or more data storage devices. The processor is configured to receive the filtered card transaction records, and update one or more subscription records in the subscription record database according to identifiers contained in the authorization data associated with corresponding filtered transaction records, for generating subscription information for one or more transactions of an account holder and a corresponding merchant. Each subscription record includes: a cardholder account identifier field, a merchant identifier field, a first date indicator field identifying the date on which the subscription began, a last date indicator field identifying the date of the most recent transaction for the subscription, and an end date indicator or end date field. The end date indicator or end date field may be blank while the subscription is active, and then populated with data indicative of an expected date the subscription is to end, or subscription end date, according to a frequency indicator identifying the expected frequency by which transaction messages for a given subscription are to be updated.

In some embodiments, a computer system includes one or more data storage devices storing data indicative of approved transaction messages made over a card payment network, a server processor in communication with the one or more data storage devices and a memory, in communication with the server processor. The memory stores processor-executable instructions, which, when executed by the server processor, cause the server processor to receive, in a periodic batch extraction, from the one or more data storage devices, a plurality of the approved transaction messages made over the card payment network. Each of said approved transaction messages includes an account identifier data field, a merchant data field, an approved transaction date field, an amount field, an authorization data field and a clearance data field. The instructions further cause the server processor to filter the received approved transaction messages, using a filter configured to pass exclusively transaction messages containing a merchant identifier data field value corresponding to one of a plurality of passing merchant identifier data field values, the passing merchant identifier data field values corresponding exclusively to merchants offering a periodic subscription for services and process each filtered approved transaction message. The processing includes writing a new subscription record for a given transaction on a data storage medium to generate a new record in a subscription record database responsive to determining that the transaction represents a new subscription record, based at least on the merchant identifier data and account data in the transaction, and accessing the subscription record database and periodically updating one or more of the existing subscriptions records in the subscription record database. The filtering and the accessing the subscription record database provide reduced load on the server processor.

### BRIEF DESCRIPTION OF THE DRAWINGS

FIG. 1 is a schematic diagram illustrating an exemplary multi-party payment card system in which some embodiments may be implemented.

FIG. 2 is a functional block diagram of a data processing system for a payment card service provider in accordance with an exemplary embodiment.

FIG. 3 illustrates an exemplary expanded block diagram of an embodiment of a server architecture of a payment card service provider in accordance with an exemplary embodiment.

FIG. 4 illustrates an exemplary client side computer system useful in implementing some embodiments of the present system and method.

FIG. 5 illustrates an exemplary process flow diagram of a computerized method useful in implementing some embodiments of the present system and method.

FIG. 6 illustrates an exemplary data table showing illustrative data in a database useful in implementing some embodiments of the present system and method.

FIG. 7 illustrates an exemplary process flow diagram of a computerized method useful in implementing some embodiments of the present system and method.

FIG. 8 illustrates an exemplary process flow diagram of a computerized method useful in implementing some embodiments of the present system and method.

### DETAILED DESCRIPTION

Disclosed herein are processor-executable methods, computing systems, and related processing relating to payment card networks and payment card messages transmitted via payment card networks. Technological developments in the field of payment card networks and data security have made available simplified systems for provision of products and services in a subscription arrangement. In subscription arrangements of this type, the purchaser provides payments to the merchant on a recurring cycle, in an even amount. For example, the recurring cycle may be monthly, quarterly, annually, or another period. However, a monthly period is very common in current arrangements. In return, the merchant provides access to a resource on an ongoing basis, such as access to streaming or downloadable media, software, and a wide variety of other services. Improvements in technology around data security have made it possible for merchants to receive payment card data, store the payment card data on an ongoing basis, and receive prior authorization from the cardholder for the recurring charges. The merchant then submits transactions via the payment card network for approval on a recurring basis, without the need to obtain authorization from the cardholder for each payment. Without both payment card networks and advances in data security, such recurring transactions would not be feasible.

The new technological arrangement of recurring payments via payment card networks has generated a further innovation related to subscription services. Free trial periods of access to subscription services are made available contingent on receipt via a payment card network of an approval of a submitted transaction in an amount less than the level amount for the subscription. For example, the amount of the submitted transaction may be zero, or it may be a nominal amount, such as a minimum available amount in local currency, such as one cent in the U.S. or Canada. If the transaction in the amount less than the level amount for the subscription is approved via the payment card network, then the merchant provides the good or services to the customer. The merchant then submits for approval via the payment card network transactions on a recurring basis in level amounts. These transactions are then approved, and further network steps are taken to provide payment to the merchant.

A challenge that has arisen as a result of the availability of payment card networks, data security around payment card data, and the practice of providing an initial trial period of access, is that some card accounts may be used, on a recurring basis, to obtain access to services for the trial period, with the service canceled prior to submission by the merchant via the payment network of a first transaction at the level payment amount. As a result, merchants lose the benefit of recurring payments via the payment card network based on approved recurring transactions via the payment card network.

It would be desirable to leverage payment card network transaction data to identify card accounts characterized by approved initial zero amount or nominal amount payment card transactions that are not followed by later approved recurring payment card transactions for the same merchants. In embodiments, the present system is configured to identify subscriptions among payment card transaction records, and to identify card accounts that are characterized by zero value or nominal value approved card transactions with merchants offering subscriptions, without recurring subscription payment card transactions being later submitted via the payment card network by the same merchant. In embodiments, responsive to identification of such card accounts, the account may be flagged as a subscription hopper. In response, upon receipt by the payment card processor of a request for approval of a zero value or nominal value payment card transaction, a code may be returned indicative of the flagging of the account. In response, merchant systems may be configured to automatically modify delivery of services to users associated with the account, such as by reducing available times of service, slowing download speeds, changing frame rates, inserting advertising messages, and other techniques. In embodiments, the system may be configured to provide reports of analyses of data indicating accounts associated with recurring payments following trial periods, trends in use of payment card networks for recurring payments, and other analyses.

A technological challenge encountered in the analysis of payment card transaction record data to identify subscription based payment card transaction trends and patterns is the large size of databases of payment card transactions. A payment card transaction provider, such as MasterCard, will have millions of approved transactions added to its payment card transaction databases on a daily basis. As a result, search times for identification of patterns and trends will be high, and the use of processor and other hardware resources consequently very high. A solution to this technological challenge is the filtering of approved payment card transactions using a filter that only passes approved payment card transaction records having a merchant identifier associated with subscription use of payment card networks, and building a new database including only those payment card transaction records associated with those transactions. This solution reduces the search time and use of processor and other hardware resources that would otherwise be associated with identification of payment card transactions

Based on the novel database, as disclosed herein in greater detail, embodiments disclose methods and systems for efficiently providing analyses, including identifying subscription hoppers, providing predictive insights on future behaviors of subscribers, and as well as evaluating the effectiveness of their promotions.

It is to be understood that a payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

A “payment card processing system” or “credit card processing network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

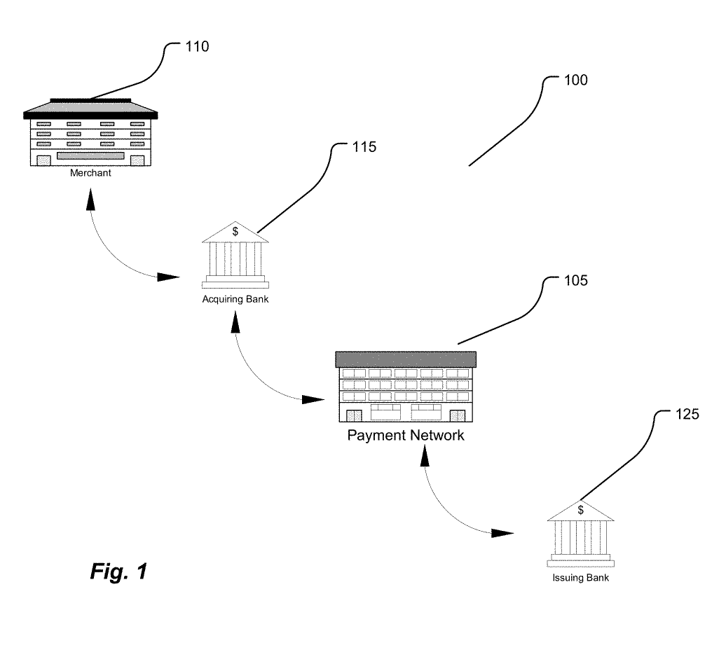

Referring now to FIG. 1, there is shown a schematic diagram illustrating an exemplary multi-party payment card system 100 in which some embodiments may be implemented. Payment card system 100 may be a credit card payment system using the MasterCard® payment card system payment network 105. Such payment networks are also referred to as interchanges and interchange networks. Such payment networks provide for transmission of messages compliant with an applicable interchange message specification, such as ISO 8583. Such messages may be of variable length, and include a Message Type Indicator field, which may specify a version of the applicable standard, a message class, a message function and message origin, and may be a 4 digit numeric field. The following field may be a bitmap that indicates which other data elements or data element subfields will be present. Data fields may include primary account number, transaction amount, transmission date and time, time, date, expiration date, merchant type, acquiring institution identification code, forwarding institution identification code, card acceptor terminal identification, card acceptor identification code, and card acceptor name/location. MasterCard® payment card system payment network is a proprietary communications standard promulgated by MasterCard International Incorporated for the exchange of financial transaction data between financial institutions that are members of MasterCard International Incorporated® (MasterCard is a registered trademark of MasterCard International Incorporated located in Purchase, N.Y.).

In payment card system 100, a financial institution 125, termed an issuer, has issued a payment account card, such as a credit card account or a debit card account, to a cardholder. Merchants have established accounts with financial institutions that are termed acquirer or acquiring bank in the transaction system. A transaction commences when a cardholder tenders a card to merchant 110 for payment. Card information is captured by merchant devices, such as a point of sale dedicated device via swiping of a card or chip technology, via a secure Internet connection, or via another technique. In the context of subscription accounts, the card data for the initial payment card transaction is generally captured via a secure Internet connection. The merchant system transmits a payment card transaction message via a secure communications channel to credit card processing computer systems of acquiring bank 115. The credit card processing computer systems of acquiring bank 115 then transmits a message requesting transaction approval to a payment card processing system authorization network. The payment card processing system authorization network in turn determines the issuer bank and transmits a message requesting transaction approval to the credit card processing computer system of the issuer bank. The issuer bank payment card processing computer systems determine whether to approve the transaction, by determining whether the credit limit is sufficient, if any of the data included in the message requesting approval is indicative of fraud, and then provides a return message to the payment card processing system authorization network. The return message may indicate approval of the transaction, declining of the transaction, and optionally other messages with declining of the transaction, such as an instruction to hold the card. The payment card processing system authorization network then transmits the message to the acquirer computer system. The payment card processing system also stores data indicative of the approved transaction message in a database of approved payment card transactions. A message including approval is then transmitted from the acquiring bank system to the merchant point of sale device or other merchant systems.

The request from the merchant 110 to the acquiring bank 115 may be performed over the telephone, as an alternative to the use of a dedicated point-of-sale or point-of-interaction terminal, which reads the cardholder's account information from the magnetic stripe on the payment account card or EMV chip and communicates electronically with the transaction processing computers of acquirer 115. Alternatively, acquirer 115 may authorize a third party to perform transaction processing on its behalf. In this case, the point-of-interaction terminal will be configured to communicate with the third party. Such a third party is usually called a “merchant processor” or an “acquiring processor.” As noted, for subscriptions, a merchant stores payment card information associated with a cardholder and generates a message requesting authorization from acquirer 115 using the stored payment card information, on a recurring basis. Such transactions are referred to herein as card-on-file (COF) transactions.

When a request for authorization is accepted, the issuer bank systems engage in certain steps. At an appropriate time, the available credit line or available balance of the cardholder's account is decreased. In certain situations, a charge is not posted immediately to a cardholder's account because bankcard associations, such as MasterCard International Incorporated, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For PIN debit card transactions, when a request for authorization is approved by the issuer, the cardholder's account is decreased. Normally, a charge is posted immediately to cardholder's account. The bankcard association then transmits the approval to the acquiring processor for distribution of goods/services, or information or cash in the case of an ATM.

After a transaction is captured, the transaction is cleared and settled between merchant 110, acquirer 115, and issuer 125. Clearing refers to the communication of financial data for reconciliation purposes between the parties. Settlement refers to the transfer of funds between the merchant's account, acquirer, and issuer related to the transaction.

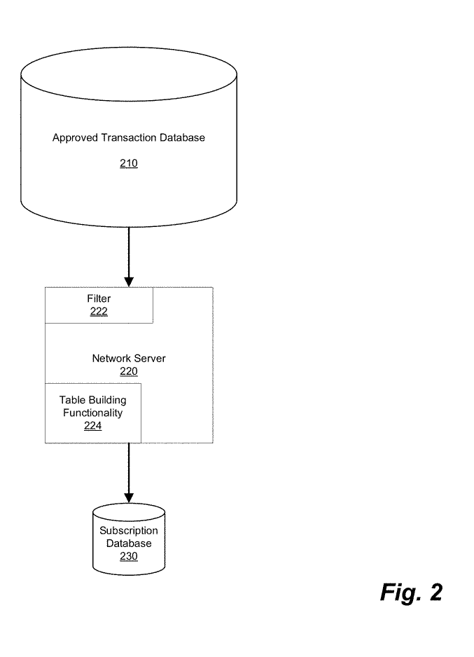

Referring now to FIG. 2, there is shown a functional block diagram of a data processing system for a payment card service provider in accordance with an exemplary embodiment. Approved transaction database 210 is shown. Database 210 includes one or more logical databases, stored on a plurality of data storage devices at one or more physical locations. Approved transaction database 210 includes tens of millions of records of approved transactions.

Network server 220 includes filtering functionality 222, which may be implemented in software or firmware, for example. Firmware implementation may provide enhanced throughput capacity, which may be advantageous in view of the very large size of an approved transaction database. Filtering functionality 222 removes all approved transactions other than those having merchant identifiers corresponding to those stored and applied by the filter. In embodiments, the filtering functionality may be performed on a batch basis, as a periodic batch extraction process. The period of the periodic batch extraction process may be any suitable period, such as once daily, every 12 hours, every six hours, or other periods. The approved transaction records that pass the filter are then provided to the table building functionality 224 to build the subscription table 230. The table building functionality 224 may be embodied in one or more modules. The subscription table 230 may be a database, stored on one or more data storage devices, such as by a data storage server. Subscription table 230 is orders of magnitude smaller, in terms of numbers of records, as compared to the approved transaction database 210.

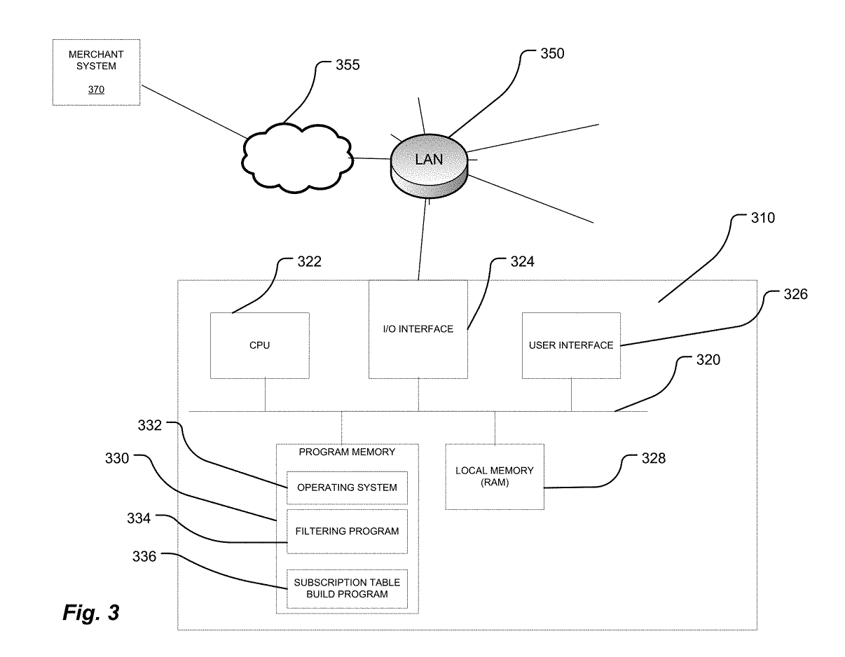

Referring now to FIG. 3, there is shown an expanded block diagram of a sever architecture of the subscriber analysis system in accordance with some embodiments. Network server 310 includes exemplary data bus 320 providing communication among system components. One or more computer processors, designated by central processing unit (CPU) 322, are in communication via data bus 320 with components including program memory 330, local memory 328, user interface 326, and input/output interface 324. Program memory 330 stores programs including an operating system (OS) 332, which manages the computer hardware and provides common services for efficient execution of various logic circuitry including hardware, software and/or programs. Program memory 330 further stores application software, such as filtering program 334, which includes computer-executable instructions to filter approved transaction records. In embodiments, program memory 330 may include subscription table build program 336, which includes computer-executable instructions to build and manage the subscription table. Program memory 330 further may include a device communication management program, which includes computer-executable instructions to manage communications, particularly communications of approved transaction data, and communications with third party computer systems, such as merchant computer systems. The processor 322 (or CPU) carries out the instructions of computer programs, which operates and/or controls at least a portion of the functionality of the network server. Program instructions may be loaded into local memory 328 for efficient and high-speed execution by CPU 322. Programs may be arranged in one or more modules, and functionality of programs may be implemented in program code that may be arranged as one or more programs or modules, which need not be stored on a same memory device, or executed by a single CPU.

Network server 310 further includes device input/output interface 324 configured to receive and output data such as data relating to card accounts identified as associated with subscription hopper behavior, reports derived from analysis of the subscription table, and other data communications, from and/or to peripheral devices and networks operatively coupled to the system. Such networks may include exemplary local area network 350, which manages communications among devices within a card services provider system or third party system. Data storage devices and associated management systems, such as hardware and software for database management systems, may be coupled to local area network 350. Local area network 350 may further be coupled, via one or more intermediary communication devices, such as firewall systems and other access management systems, (not shown), to network 355, which may be or include the Internet, as well as other wired and/or wireless networks, to remote devices and remote systems such as exemplary merchant system 370. The I/O interface 324 may include a query interface configured to accept and parse requests from remote user devices and pass those requests to CPU 322 for processing using instructions of stored programs, for analysis of data in the subscription database, as well as for user permissions and verification, by way of example. The I/O interface 324 may be configured to push data, such as updated analysis data, or data indicative of a received approved transaction associated with a card account identified as associated with subscription hopper behavior, to external systems, such as merchant system 370, to cause the merchant systems to modify the delivery of products and services, even in the absence of a request, in embodiments.

The program memory 330 may include one or more of any form of data storage device including but not limited to electronic, magnetic, optical recording mechanisms, combinations thereof or any other form of memory device capable of storing data. The CPU 322 may be in the form of one or more computer processors, or may be in such forms as a distributed computing system, a centralized computing system, a network server with communication modules and other processors, or nearly any other automated information processing system capable of executing instructions stored in program memory. The present systems may be embodied as a data warehouse or repository for storing, managing and processing volumes of subscription data.

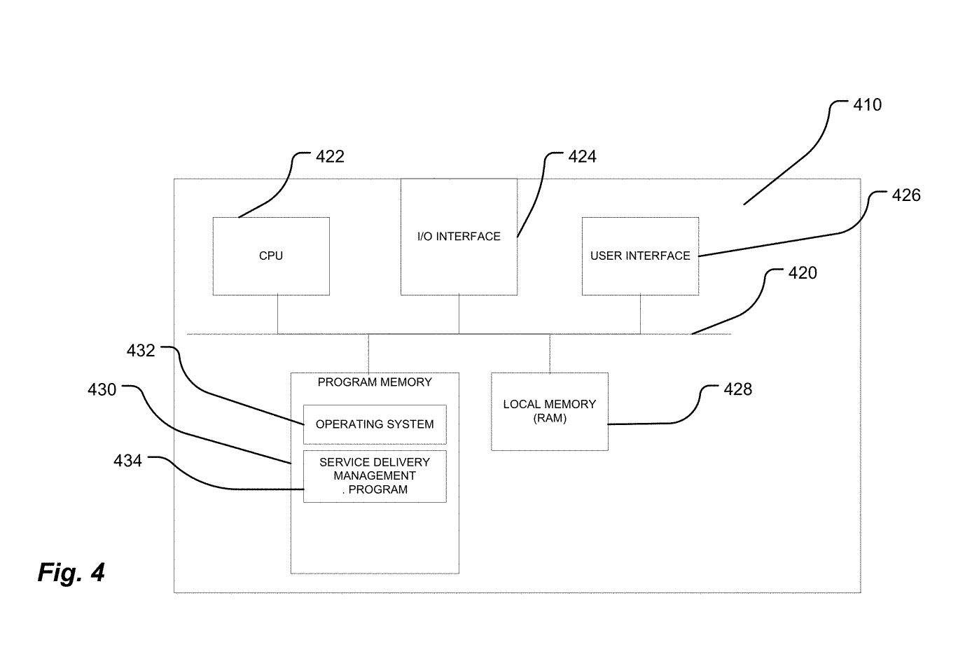

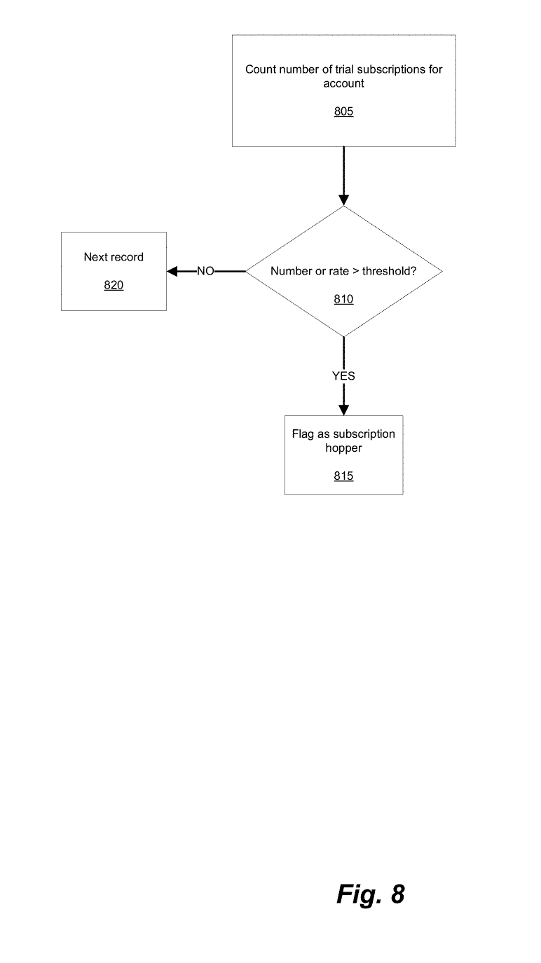

Referring now to FIG. 4, there is shown a merchant computer system in communication with the network system of FIG. 3. The merchant computer system includes exemplary data bus 420 providing communication among system components. One or more computer processors, designated by central processing unit (CPU) 422, are in communication via data bus 420 with components including program memory 430, local memory 428, user interface 426, and input/output interface 424. Program memory 430 stores programs including an operating system (OS) 432, which manages the computer hardware and provides common services for efficient execution of various logic circuitry including hardware, software and/or programs. Program memory 430 further stores application software, such as service delivery management program 434, which includes computer-executable instructions to cause services to be provided to subscribers, or includes instructions to cause other merchant computer systems to automatically modify the provision of services responsive to receipt of an indication that a card account is associated with subscription hopper behavior. Such modifications may include modifications in speed or rate of delivery, such as rates of delivery of media, or changes in quality of media (e.g., reducing bitrate, reducing frame rate, modifying compression to reduce volume of data transmitted), or reducing frequency of service or value or volume of service provided. The merchant system may request from a bankcard system or third party system an indication of whether or not a given account exhibits subscription hopper behavior. The bankcard or third party system may, responsive to the request, determine whether the account exhibits subscription hopper behavior, as described below in connection with FIG. 8, for example, and provide a return message to the merchant system with the indication of the subscription hopper status of the account. Responsive to receipt of a message with a positive indication of the subscription hopper status of the account, the CPU may, under the control of service delivery management program, provide services in a modified manner as compared to standard rates, formats or other manners, or terminate service by way of example. In embodiments, the CPU may generate a control signal to another merchant system to implement the provision of services in a modified manner or the termination of services.

Program memory 430 may further include programs, such as database management or spreadsheet programs, to facilitate display and analysis of reports provided on subscription analysis. Program memory 430 further includes communication management program 438, which includes computer-executable instructions to manage communications, particularly communications of data indicative of analyses of approved transaction data. The processor 422 (or CPU) carries out the instructions of computer programs, which operates and/or controls at least a portion of the functionality of the network server. Program instructions may be loaded into local memory 428 for efficient and high-speed execution by CPU 422. Programs may be arranged in one or more modules, and functionality of programs may be implemented in program code that may be arranged as one or more programs or modules, which need not be stored on a same memory device, or executed by a single CPU.

Merchant computer system 410 further includes device input/output interface 424 configured to receive and output data such as data relating to card accounts identified as associated with subscription hopper behavior, reports derived from analysis of the subscription table, and other data communications, from and/or to peripheral devices and networks operatively coupled to the system.

The program memory 430 may include one or more of any form of data storage device including but not limited to electronic, magnetic, optical recording mechanisms, combinations thereof or any other form of memory device capable of storing data. The CPU 422 may be in the form of one or more computer processors, or may be in such forms as a distributed computing system, a centralized computing system, a network server with communication modules and other processors, or nearly any other automated information processing system capable of executing instructions stored in program memory.

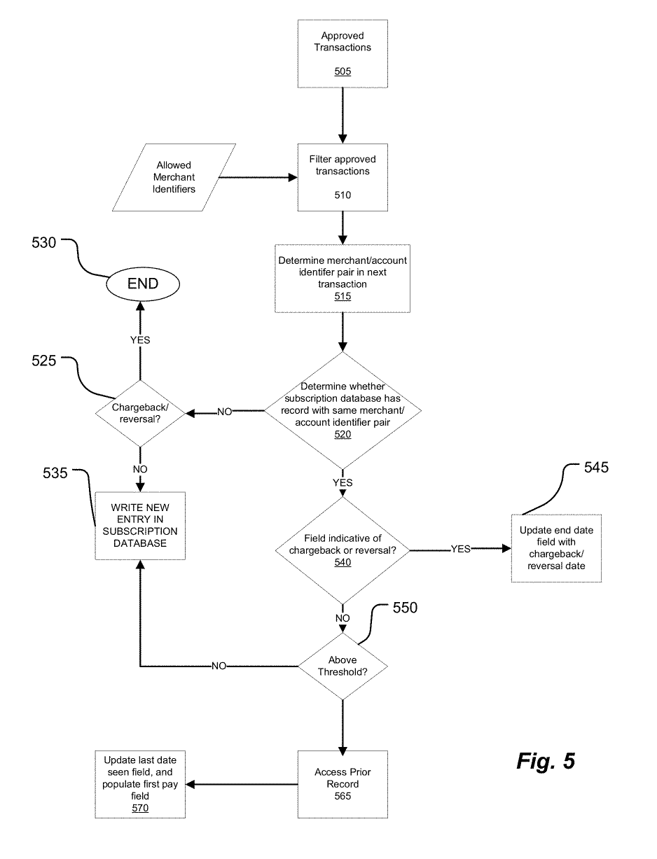

Referring now to FIG. 5, there is shown a flow diagram of an exemplary computer-implemented process flow performed by a network server system according to some embodiments. As indicated at 505, approved transaction records are received. Receipt may be on a periodic batch basis, for example. Approved transaction records are filtered 510 employing a list of allowed merchant identifiers. Updating of the subscription record table may then be determined for each approved transaction record, using, for example, the following order. The combination of account identifier and merchant identifier in the record is determined 515. The combination is then compared 520 to the records in the subscription record database. Responsive to detecting that the combination of account identifier and merchant identifier in the record does not occur in any record in the subscription record database, i.e., that the combination is a first occurrence of that combination, the process flow proceeds to check whether the approved transaction record includes a field indicative of a chargeback or a reversal 525. Responsive to determining that the approved transaction record includes a field indicative of a chargeback or a reversal, then no data relating to the approved transaction record is stored 530 in the subscription record database. Such a chargeback or reversal, with no existing combination of merchant identifier and account number, indicates that there is no ongoing subscription.

Responsive to determining that the approved transaction record does not include fields indicative of either a chargeback or a reversal, then the process flow proceeds to generating and writing a new record 535 in the subscription record table. The new combination, and lack of chargeback or reversal, indicates that a new subscription has commenced. The data stored in the record includes at least the account identifier, merchant identifier, a first date the subscription starts, a promotional indicator, and a frequency, which may be obtained based on existing records.

Responsive to determining, at 520, that the account identifier and merchant identifier combination already exists in the subscription record database, the process flow may proceed to determining whether the approved transaction is a chargeback or reversal 540. Responsive to determining that the transaction is a chargeback or reversal, the corresponding record in the subscription database is updated 545 with the date of the chargeback or reversal as the updated end date of the subscription. An end type code is also updated to indicate a cancellation of the subscription.

Responsive to determining that the approved transaction is not a chargeback or a reversal, the transaction amount is then compared 550 to a threshold value. The threshold value may be zero, or may be a nominal or low value in applicable currency. The threshold value may be a value sufficiently low to be indicative of a subscription trial period. Responsive to determining that the transaction amount is not more than the threshold, the process proceeds to generation 535 of a new record for insertion in the subscription database.

Responsive to determining that the transaction amount is in excess of the threshold, the process flow proceeds to accessing 565 from the subscription database a record having the same merchant identifier/card account identifier pair. The process flow then proceeds to update 570 the last seen date field with a date of the approved transaction, and populate the first paid date field, if not populated, with the current transaction date.

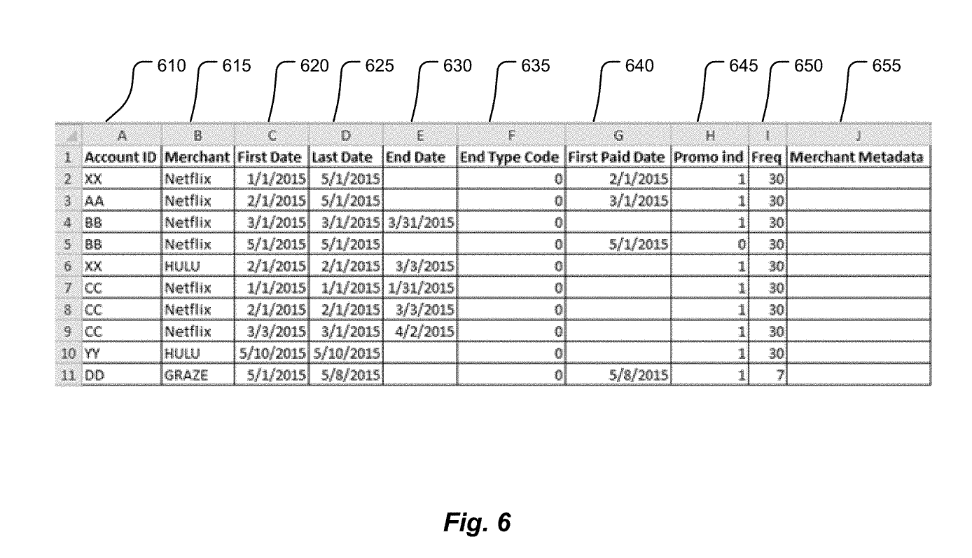

Referring now to FIG. 6, there is shown an exemplary data table 600 for the subscription record data base in some embodiments. Each row represents a subscription identified by the process flow of FIG. 5. Each subscription has an account identifier data field 610, representing a card account; a merchant identifier data field 615 having a value that may be a merchant name, as shown, or a numeric or alphanumeric identifier; a date of first approved transaction associated with the subscription, 620; a date of most recent approved transaction 625; a date of end of the subscription 630; an end type code field 635; a first paid date 640; a promotional indicator 645, which is a binary indicator; a frequency 650, which is a numeric value, and an additional field, which is labeled merchant metadata 655.

The system derives the date of first approved transaction from the date of the approved transaction that causes the system to create the new record. The date of the most recent approved transaction is also a date from an approved transaction record, and is a date from an approved transaction, that is not the first with the account/merchant identifier pair, not a chargeback or a reversal, is greater than the threshold, for a subscription that does not have an end date. The date of the end of the subscription is either the date of a chargeback or reversal, or an inferred date based on the date of the most recent approved transaction and the frequency, as explained below. The end type code has a value depending on the reason for determination of an end date, e.g., chargeback or reversal, or cancellation inferred from the date of the most recent approved transaction and the frequency. The first paid date is the date of the first approved transaction for the subscription with a first payment, as opposed to a zero or not greater than threshold value transaction. The promotional indicator has a value depending on whether the first paid date is subsequent to the first date, in which case the promotional indicator is positive, or the first paid date is the same as the first date, in which case the promotional indicator is negative. The frequency is a value of the frequency between payments for the subscription. The value may be determined based on data associated with the merchant, which may, in embodiments, be determined based on analyzing merchant approved transaction data. It will be appreciated that the tabular representation is merely for convenience.

Referring now to the table, the first two rows, labeled 2 and 3, represent account/merchant identifier combinations for current subscriptions with a promotional period. The first date and the first paid date in both are different, and the end date and end type code are blank. Row 4 represents a subscription that ended without a first payment. Row 5 represents a subscription having the same account/merchant pair as Row 4; as the end date was populated in Row 4, and the first transaction date was not a zero value or not above threshold amount (as shown by the date in the first paid date field), a new subscription record was created. Row 6 shows a subscription that has ended, by the same subscriber as in Row 2. Rows 7-9 show subscriptions with the same account/merchant pair, each being a free trial, as the first paid date is blank in each one, and each being terminated. The presence of multiple subscriptions having an end date and no first paid date for a same account is indicate of a subscription hopper. Row 10 represents a new subscription, in which the first date and last date are the same. Row 11 represents a subscription in which the frequency is weekly, with a one week trial completed.

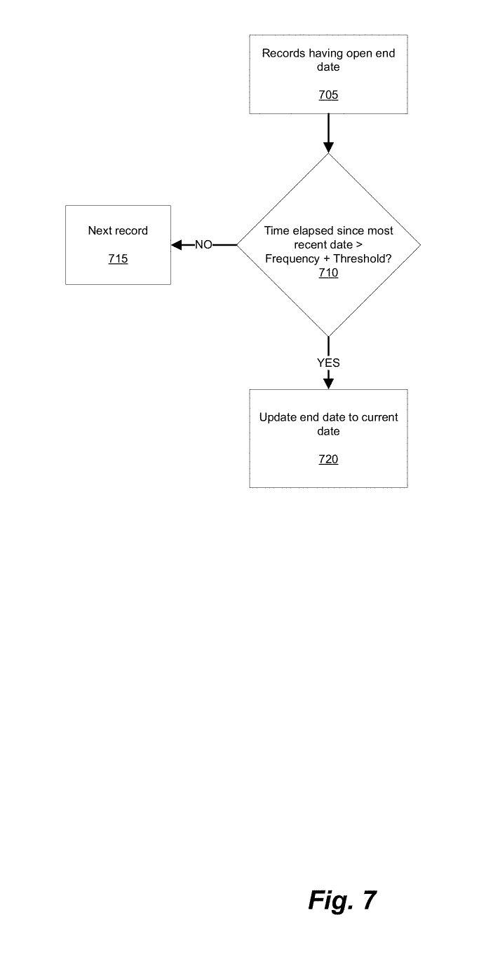

Referring now to FIG. 7, an exemplary process flow diagram showing a process of updating records in the subscription database is shown. On a periodic basis, the records not having a populated end date are accessed 705. The last transaction date, plus the frequency, is compared to the current date 710, and a threshold value, such as 1 to 5 days, may be included. If the resulting date is prior to the current date, then the process flow proceeds 715 to the next record. If the resulting date is the current date or later, then it is inferred that the subscription has been canceled, and the field for the end date is populated with the current date 720. The field for the end type code may also be populated with a value indicating a cancellation. The record will accordingly indicate a completed subscription. If the same account/merchant identifier pair is received in a new approved transaction record, the system will generate a new subscription record in the table.

Referring now to FIG. 8, an exemplary process flow diagram showing a process of applying the subscription record database to identify account identifiers associated with subscription hopper behavior. In embodiments, the process may be performed by CPU 322 of FIG. 3, responsive to data indicative of a request for identification of accounts having subscription hopper behavior, from merchant system 370 via Internet 355 and LAN 350. Referring again to FIG. 8, for each account identifier, the number of subscriptions is counted 805. The count may be for the entire database, for a particular merchant, for one or more business categories, such as SIC code, of merchant, or on other bases. The number identified is then compared 810 to a threshold value. In embodiments, the threshold may be a rate; for example, the count may be divided by the time in years from the earliest first date associated with the account identifier to the present to identify an annual rate of subscription use. If the count exceeds the threshold value or rate, the system associates 815 a flag or field value indicative of a subscription hopper in the database. Responsive to determining that the count does not exceed the threshold value or rate, the system proceeds 820 to a next record. In embodiments, the system may provide for multiple thresholds of counts or rates, and multiple subscription hopper flags or labels, each flag or labels corresponding to a count or rate between two of the multiple thresholds. Thus, different flags may be understood, by way of example, as representing a low level of subscription hopper behavior, a moderate level of subscription hopper behavior, and a high level of subscription hopper behavior.

In embodiments, subscription record database data may be analyzed to determine success of promotional efforts, both on an absolute basis and relative to other similar businesses. Such metrics as percentage of loyal subscribers, e.g., those who maintain a paid account for a period exceeding a threshold, divided by total numbers of subscribers; average and other statistical measures of subscription duration; rate of cancellation, may be determined. In embodiments, the likelihood of a given subscription being continued may be determined over numerous accounts, or at an account level, based on subscriber history and history of similar subscriptions. In embodiments, via a suitable authentication, the merchant computer system may provide instructions to a server system to conduct such analyses of subscription record database data. The server system may responsive to such instructions, conduct such analyses, generate one or more reports setting forth data indicative of the results of the analyses, and transmit the one or more reports to the merchant computer system.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems.

The embodiments described herein are solely for the purpose of illustration. Those in the art will recognize that other embodiments may be practiced with modifications and alterations limited only by the claims.

What is claimed is:

1. A computerized method for processing payment card transaction data, comprising:
receiving, by a server processor, in a periodic batch extraction, from a data warehouse, a plurality of approved transaction messages made over a card payment network and stored in a payment card network database, each of said approved transaction messages including an account identifier data field, a merchant data field, an approved transaction date field, an amount field, authorization data field and clearance data field;
filtering, by the server processor, the received approved transaction messages, using a filter, stored in memory and accessed by the server processor and loaded in random access memory, configured to pass exclusively transaction messages containing a merchant identifier data field value corresponding to one of a plurality of passing merchant identifier data field values, the passing merchant identifier data field values corresponding exclusively to merchants offering a periodic subscription for its services; and
processing each filtered approved transaction message, said processing comprising:
writing a new subscription record for a given transaction on a data storage medium to generate a new record in a subscription record database responsive to determining that the transaction represents a new subscription record, based at least on the merchant identifier data and account data in the transaction; and
periodically updating one or more of the existing subscriptions records in the subscription record database.

2. The computerized method of claim 1, wherein the processing comprises writing a new subscription record responsive to detecting that the merchant identifier and account identifier combination in said approved transaction message is a first occurrence in said subscription record database, and not detecting a transaction chargeback or reversal in said transaction data.

3. The computerized method of claim 1, wherein the processing comprises writing a new subscription record responsive to detecting in said subscription record database an occurrence of the merchant identifier and account identifier combination, and not detecting a transaction chargeback or reversal in said transaction data, and determining that the transaction amount is not greater than a threshold value indicative of the subscription having a subscription trial period.

4. The computerized method of claim 1, wherein the processing comprises writing a new subscription record responsive to determining that the transaction amount is not indicative of the subscription having a subscription trial period, and detects that each record associated with the merchant identifier and account identifier combination has an end date field populated indicative of a subscription end date.

5. The computerized method of claim 1, wherein the periodically updating comprises periodically updating one or more of the existing subscription records in said subscription table to identify a subscription end date for the subscription record associated with the subscription with the merchant.

6. The computerized method of claim 5, wherein the identifying the subscription end date comprises identifying a detected difference between a last transaction date and an expected transaction date in excess of a given threshold value for the particular customer and merchant combination.

7. A computer system, comprising:
one or more communications devices for communicating filtered card transaction records;
one or more data storage devices storing a subscription record database;
a processor, in communication with the one or more data storage devices, and configured to:
receive the filtered card transaction records;
update one or more subscription records in the subscription record database according to identifiers contained in the authorization data associated with corresponding filtered transaction records, for generating subscription information for one or more transactions of an account holder and a corresponding merchant;
wherein each subscription record includes: a cardholder account identifier and merchant identifier combination, a first date indicator identifying the date on which the subscription began, a last date indicator identifying when the most recent transaction for said subscription occurred, and an end date indicator identifying the expected date the subscription is to end according to a frequency indicator identifying the expected frequency by which transaction messages for a given subscription are to be updated.

8. The computer system of claim 7, wherein the processor is further configured to write a new subscription record to the subscription record database responsive to detecting that a merchant identifier and account identifier combination in the authorization data associated with one of the filtered transaction records is a first occurrence of the combination in said subscription record database, and not detecting a transaction chargeback or reversal in said authorization data.

9. The computer system of claim 7, wherein the processor is further configured to write a new subscription record to the subscription record database responsive to detecting in said subscription record database an occurrence of a merchant identifier and account identifier combination in the authorization data associated with one of the filtered transaction records, and not detecting a transaction chargeback or reversal in said authorization data, and determining that the transaction amount is not greater than a threshold value indicative of the subscription having a subscription trial period.

10. The computer system of claim 7, wherein the processor is further configured to write a new subscription record in the subscription record database responsive to determining that a transaction amount in the authorization data associated with one of the filtered transaction records is not indicative of the subscription having a subscription trial period, and to detecting that each record associated with the merchant identifier and account identifier combination has an end date field populated indicative of a subscription end date.

11. The computer system of claim 7, wherein the processor is further configured to periodically update one or more of the existing subscription records in said subscription record database to identify a subscription end date for the subscription record associated with the subscription with the merchant.

12. The computer system of claim 11, wherein the processor is further configured to identify the subscription end date by identifying a detected difference between a last transaction date and an expected transaction date in excess of a given threshold value for the particular customer and merchant combination.

13. The computer system of claim 7, further comprising a filter configured to pass exclusively transaction messages containing a merchant identifier data field value corresponding to one of a plurality of passing merchant identifier data field values, the passing merchant identifier data field values corresponding exclusively to merchants offering a periodic subscription for services.

14. A computer system, comprising:
one or more data storage devices storing data indicative of approved transaction messages made over a card payment network;
a server processor in communication with the one or more data storage devices;
a memory, in communication with the server processor, the memory storing processor-executable instructions, which, when executed by the server processor, cause the server processor to:
receive, in a periodic batch extraction, from the one or more data storage devices, a plurality of the approved transaction messages made over the card payment network, each of said approved transaction messages including an account identifier data field, a merchant data field, an approved transaction date field, an amount field, an authorization data field and a clearance data field;
filter the received approved transaction messages, using a filter configured to pass exclusively transaction messages containing a merchant identifier data field value corresponding to one of a plurality of passing merchant identifier data field values, the passing merchant identifier data field values corresponding exclusively to merchants offering a periodic subscription for services; and
process each filtered approved transaction message, said processing comprising:
writing a new subscription record for a given transaction on a data storage medium to generate a new record in a subscription record database responsive to determining that the transaction represents a new subscription record, based at least on the merchant identifier data and account data in the transaction; and
accessing the subscription record database and periodically updating one or more of the existing subscriptions records in the subscription record database;
wherein the filtering and the accessing the subscription record database provide reduced load on the server processor.

15. The computer system of claim 14, wherein the instructions further cause the server processor to:
for each of a plurality of account identifiers, count a number of subscriptions;
compare the counted number of subscriptions to a threshold value;
responsive to determining that the counted number exceeds the threshold value, associate a flag indicative of a subscription hopper with the account identifier.

16. The computer system of claim 15, wherein the counting of the number of subscriptions is with respect to one of a merchant or a business category.

17. The computer system of claim 15, wherein the threshold is a rate of number of subscriptions divided by time.

18. The computer system of claim 14, wherein the memory further stores a service delivery management program including processor-executable instructions, which instructions, when executed by the server processor, cause the server processor to, responsive to data indicative of a request received via a network from a merchant computer system, perform analyses of subscription record database data, and provide a report of the analyses to the merchant computer system.
